(19) United States
(12) Patent Application Publication
(10) Pub. No.: US 2014/0331722 A1
(43) Pub. Date: Nov. 13, 2014

(54) COMPRESSION LATCH

(71) Applicant: GEM Products, Inc., Orange Park, FL (US)

(72) Inventors: Erle Matthew Bridgewater, St. Johns, FL (US); Jason Sarnowski, Jacksonville, FL (US)

(73) Assignee: GEM Products, Inc., Orange Park, FL (US)

(21) Appl. No.: 14/274,106

(22) Filed: May 9, 2014

Related U.S. Application Data
(60) Provisional application No. 61/822,532, filed on May 13, 2013.

(51) Int. Cl. E05C 5/02; E05B 13/00

(52) U.S. Cl. CPC E05C 5/02; E05B 13/002
USPC 70/57; 292/65

(57) ABSTRACT

A compression latch is disclosed that is adapted to fold down in both the locked and unlocked positions and that compresses a washer when in the closed position. The latch can couple directly to a hinged body, and does not require a separate housing that is then coupled to the hinged body. The above structure reduces leak points, creates a flush appearance, reduces the risk of injury, and allows greater customizability, as compared to prior art latches.

### CROSS REFERENCES TO RELATED APPLICATIONS

This application claims the benefit of U.S. Provisional Patent Application Ser. No. 61/822,532, filed May 13, 2013, and entitled Compression Latch, the content of which is incorporated herein by reference in its entirety.

### FIELD

The present application relates to a compression latch. More particularly, the present application relates to a compression latch capable of folding down in each of the locked and unlocked positions and coupling with a hinged body without the need for a separate housing.

### BACKGROUND

Compression latches are a common mechanism for latching a door shut, especially on marine vehicles. For example, compression latches are commonly used to selectively maintain a boat door or hatch in a closed position. One example of such a latch is shown in U.S. Pat. No. 6,953,209, depicted herein as FIG. 11. This latch 1100 includes a housing 1105 with a handle 1110 that folds down onto a face of the housing 1105 in both the locked and unlocked positions. The handle 1110 is connected to a shaft 1115 and, when rotated, rotates a pawl 1120 connected to the shaft 1115. To lock the latch 1100, the handle 1110 is rotated until the pawl 1120 abuts or is located near a catch or a door frame. The handle 1110 is then folded down, which pulls the shaft 1115 toward the housing 1105 and compresses the pawl 1120 against the catch or door frame. To unlock the latch 1100, the handle 1110 is lifted from the face of the housing 1105, releasing the compressive force, and rotated until the pawl 1120 does not abut the catch or door frame, thus allowing opening of the door.

The latch 1100 of FIG. 11 has many disadvantages. For example, the latch 1100 includes many leak points due to the housing 1105 being a crucial component of the design, which is detrimental in a marine environment. Such leak points are at the interface between the shaft 1115 and the housing 1105, and more leak points are at the interface between the housing 1105 and the hinged body to which the housing 1105 is coupled. Also, the required housing 1105 reduces the customizability of the hatch and the boat as a whole, because the housing 1105 requires a large opening to fit within the hinged body and latch it closed.

Moreover, due to the design of the housing 1105, when installed in a hatch, it does not create a flush appearance, thus causing the housing 1105 to extend from the planar surface of the hatch, not only affecting the aesthetics of the hatch, but also creating a projection that can cause physical harm, for example, to those walking on a desk boat by stubbing a toe or stepping on the latch housing.

### SUMMARY

The present application discloses a compression latch adapted to fold down in both the locked and unlocked positions and compress a washer when in the closed position to minimize leaking potential. The latch can be coupled directly to a door or hatch, and does not require a separate housing which is then coupled to the door or hatch. The present invention reduces leak points, allows greater customizability, creates a flush appearance, and reduces the possibility of injury.

The compression latch of the present application includes a shaft adapted to penetrate an aperture disposed in a recess of a hinged body. A handle is pivotably coupled to the shaft and adapted to be disposed in the recess on a first side of the hinged body. A first cam is disposed on the shaft opposite the handle and adapted to be disposed on a second side of the hinged body. The first cam is adapted to be selectively rotated between locked and unlocked positions in response to rotation of the handle.

A body is disposed on the shaft between the first cam and the hinged body, and a cap is disposed on the shaft between the first cam and the body. A bias member is disposed on the shaft between the body and the cap and adapted to bias the body toward the second side of the hinged body. In response to the handle being pivoted to an upright position, the shaft is adapted to be biased in a downwardly direction and the first cam is adapted to be rotated between the locked and unlocked positions.

The latch may also include one or more upper washers adapted to be circumferentially disposed on the shaft between the handle and the hinged body. The upper washers may include a first washer disposed proximal to the hinged body, a second washer disposed proximal to the handle, and a third washer disposed between the first and second washers. The first washer may be a sealing washer, the second washer may be a wear washer, and the third washer may be adapted to prevent over compression of the first washer.

A trim ring may also be coupled to the hinged body above the recess. The trim ring may include an aperture or opening to allow the handle to be pivoted between the upright position and a folded down position. The trim ring may include a locking tab extending into the recess. In this aspect, the handle may also include a handle lock. The handle lock may include a lock cylinder extending through the handle and a second cam adapted to extend into the recess when the handle is in the folded down position. The second cam is adapted to engage the locking tab in a handle locked position and be disengaged from the locking tab in a handle unlocked position.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a front perspective view of a latch according to an embodiment of the present application in an installed configuration.

FIG. 2 is an exploded perspective view of a latch according to an embodiment of the present application.

FIG. 3 is a side sectional view of a latch in a locked, folded-down position according to an embodiment of the present application.

FIG. 4 is a side sectional view taken along line 4-4 in FIG. 1 of the latch in an upstanding position according to an embodiment of the present application.

FIG. 5 is a side sectional view of a latch in an unlocked, upstanding position according to an embodiment of the present application.

FIG. 6 is a side sectional view of a latch in an unlocked, folded-down position according to an embodiment of the present application.

FIG. 7 is a perspective top view of a trim ring installed on a latch according to an embodiment of the present application.

FIG. 8 is a perspective top view of a trim ring installed on a latch including a handle lock according to an embodiment of the present application.

FIG. 9 is a bottom perspective view of a latch including a handle lock in an unlocked position according to an embodiment of the present application.

FIG. 10 is a bottom perspective view of a latch including a handle lock in a locked position according to an embodiment of the present application.

FIG. 11 is a prior art latch.

It should be understood that the comments included in the notes as well as the materials, dimensions and tolerances discussed therein are simply proposals such that one skilled in the art would be able to modify the proposals within the scope of the present application.

### DETAILED DESCRIPTION

While the devices, methods and systems disclosed herein are susceptible to embodiments in many different forms, there are shown in the drawings, and herein described in detail, certain embodiments of the devices, methods and systems with the understanding that the present disclosure is to be considered as an exemplification of the principles of the devices, methods and systems and is not intended to limit the broad aspects to the embodiments illustrated.

The present application discloses a compression latch that can be folded down in both the locked and unlocked positions. The latch is adapted to compress one or more washers when in the closed position. The latch can couple directly to a hinged body such as a door or hatch, and does not require a separate housing that is coupled to the hinged body. The present invention reduces leak points, creates a flush installation on a hatch, and allows greater customizability. By folding down in both the locked and unlocked positions, the latch reduces the possibility of injury where a user could trip or otherwise injure himself/herself on an outwardly-extending latch.

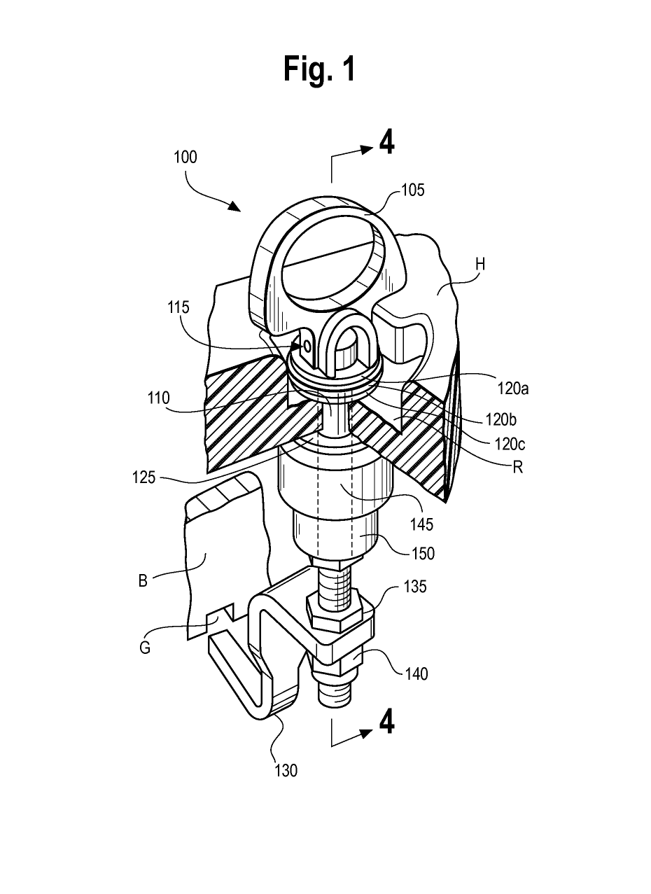

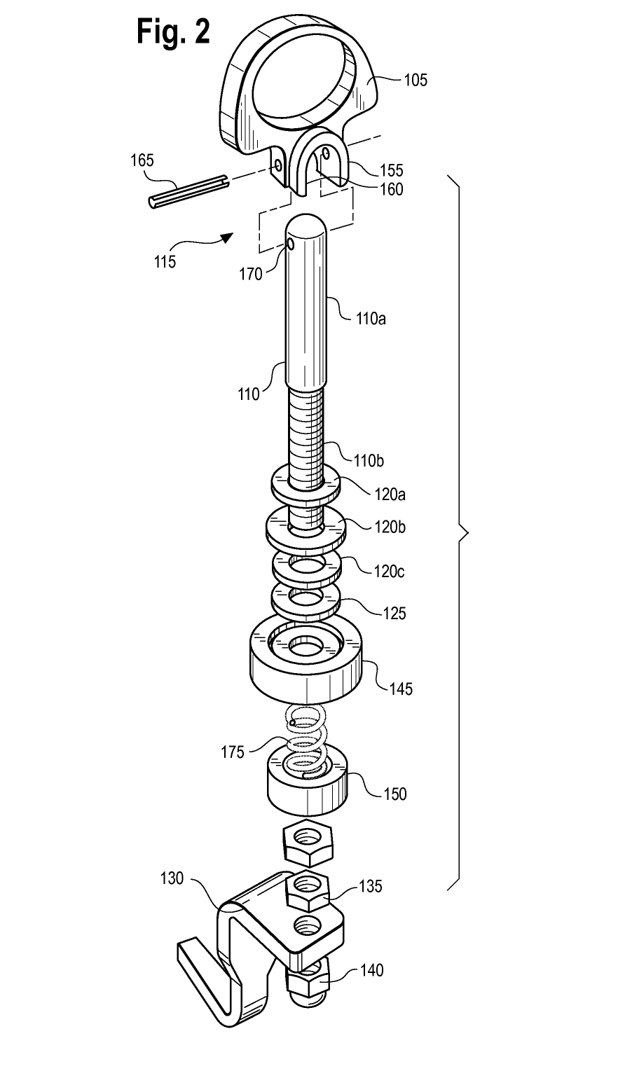

As shown in FIGS. 1 and 2, the latch 100 of the present application includes a handle 105 pivotably coupled to a shaft 110 by a joint 115, and pivotable between upstanding and folded-down positions. The latch 100 is coupled to a hinged body H, such as a door or a hatch, having a recess R integrally formed in the hinged body H. One or more upper washers 120a-120c and one or more lower washers 125 can opposingly sandwich the hinged body H and create a substantially water-tight seal when compressed against the hinged body H. For example, as illustrated, the upper washer 120c is disposed on an upper side of and against the upper surface of hinged body H, and the lower washer 125 is disposed on a lower side of and against the lower surface of hinged body H. The washers 120c and 125 may be sealing washers (such as, rubber or neoprene washers) to create a substantially water-tight seal around the aperture that the shaft 110 passes through in the hinged body H and prevent water or other liquid from entering the hole.

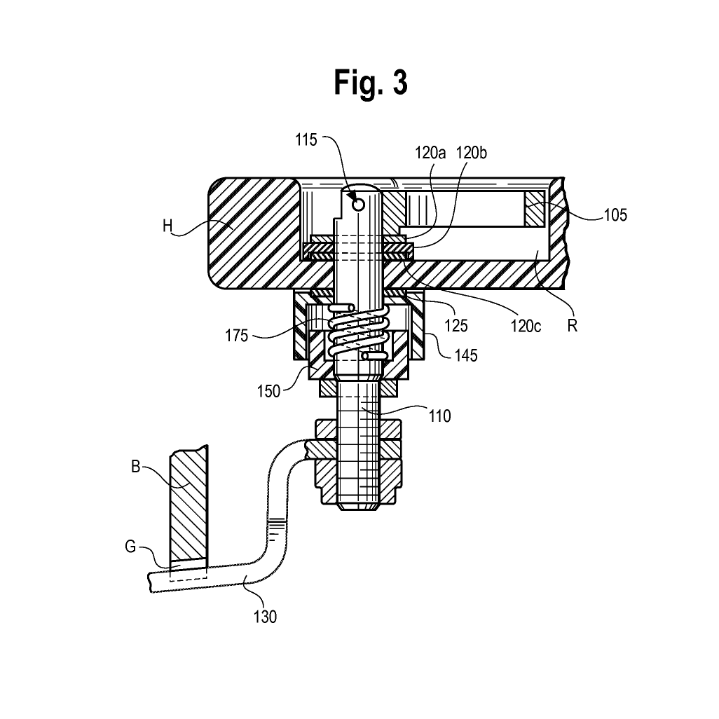

In an embodiment, upper washer 102b is disposed on the upper washer 120c, and the upper washer 120a is disposed on the upper washer 120b. The upper washer 120b may be a nylon washer that is cup-shaped having a cavity in a bottom of the upper washer 120b to receive the upper washer 120c (for example, as illustrated in FIG. 3) and prevent over compression of the upper washer 120c. The upper washer 120a may be a stainless steel wear washer that contacts the handle 105 and allows the handle 105 to pivot smoothly.

A first cam 130 can be coupled to the shaft 110 by an upper nut 135 and a lower nut 140, and when rotated, can cooperatively releasably couple the hinged body H to a base B (illustrated in FIG. 3), such as a boat deck. The base B can optionally include a gap or recess G (illustrated in FIG. 3) to receive the first cam 130. A body 145 can be provided below the lower washer 125 and can slidably receive a cap 150. The body 145 may be biased against the lower washer 125 in the locked configuration to provide a substantially water tight seal.

As shown in FIG. 2, the handle 105 can include a first member 155 and a second member 160 that form a yoke to couple the handle 105 to the shaft 110 by extending a pin 165 through first 155 and second 160 members and also through a hole 170 in the shaft 110. Together, this structure can make up the joint 115. However, the joint 115 can be any other structure capable of pivotally coupling the handle 105 to the shaft 110.

The shaft 110 can include a first portion 110a proximate the handle 105 and a second portion 115b opposite the first portion 110a and proximate the first cam 130. The first portion 110a can have a smooth finish and, as discussed above, can include a hole 170 for receiving the pin 165 of the joint 115. The second portion 110b can include threads that couple with the upper nut 135 and lower nut 140 or any other threaded body. Unthreaded bodies can also be disposed along the second portion 110b, such as the upper washers 120a-120c and lower washer 125, or any other structure.

A bias member 175 can be provided along the shaft 110, and can bias the cap 150 against the body 145 to push the lower washer 125 against the hinged body H and form a substantially water-tight seal. The cap 150 may also be prevented from sliding down on the shaft 110 by a nut. The bias member 175 may also cause the cap 150 to be pushed against the nut to cause the shaft 110 to be shifted downwardly when the handle 105 is in the upstanding position. As shown, the bias member 175 is a coil spring, but any structure capable of imparting bias can be implemented without departing from the spirit and scope of the present application. For example, the bias member 175 can be a leaf spring or any other biasing structure.

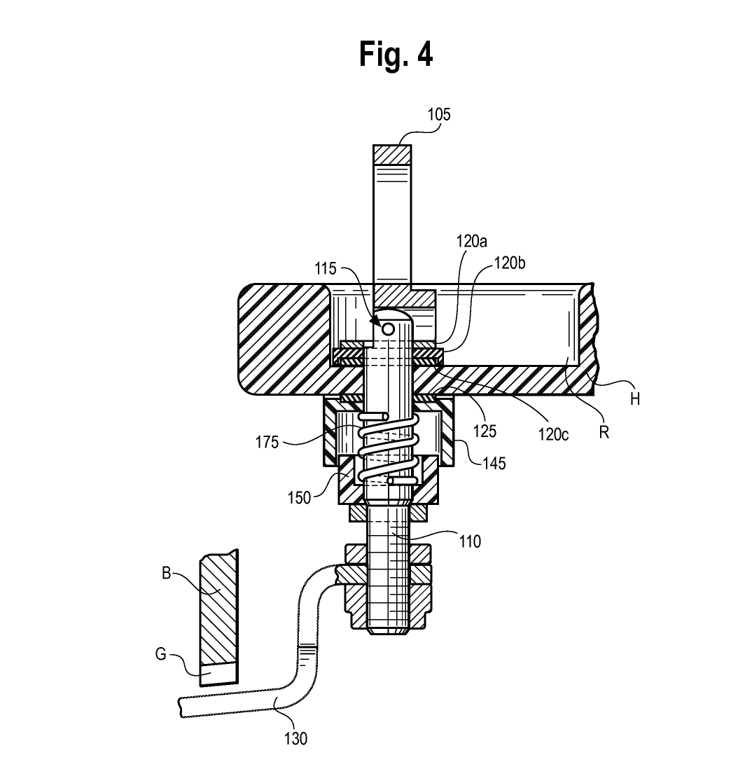

FIGS. 3-6 illustrate a process of selectively latching the hinged body H to the base B. The latch 100 is shown in the locked and folded-down position in FIG. 3. In an embodiment, the joint 115 is positioned at a top portion of the recess R, not the center. In the locked position, the cam 130 abuts base B. Accordingly, when the handle 105 is pivoted from the locked, folded-down position of FIG. 3, to the upstanding position of FIG. 4, the joint 115 shifts when the handle 105 is pivoted and is located to a position lower than before, as shown in FIG. 4. This allows the shaft 110 to be axially biased in a downwardly direction by the biasing member 175 and disengage the first cam 130 from the base B in the axial direction when the handle 105 is lifted into the upstanding position, as shown in FIG. 4.

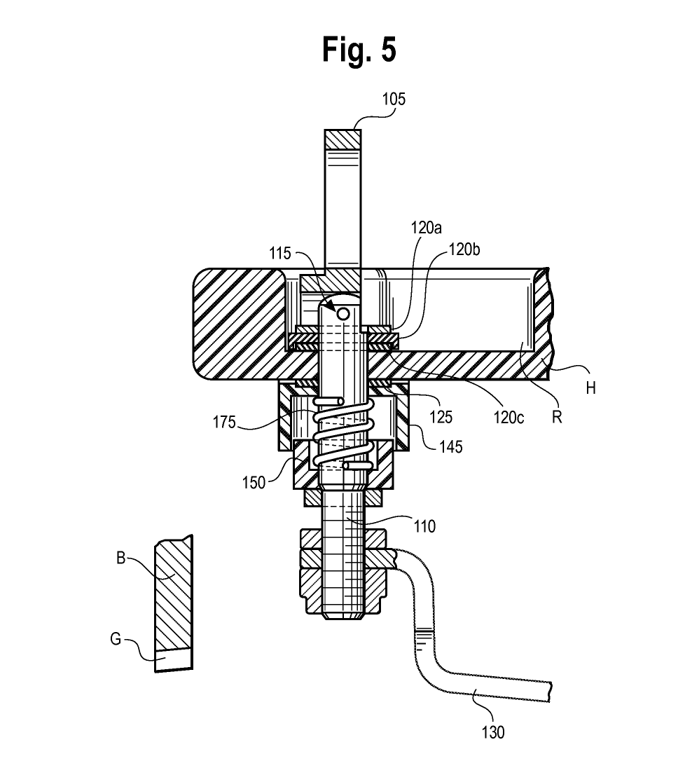

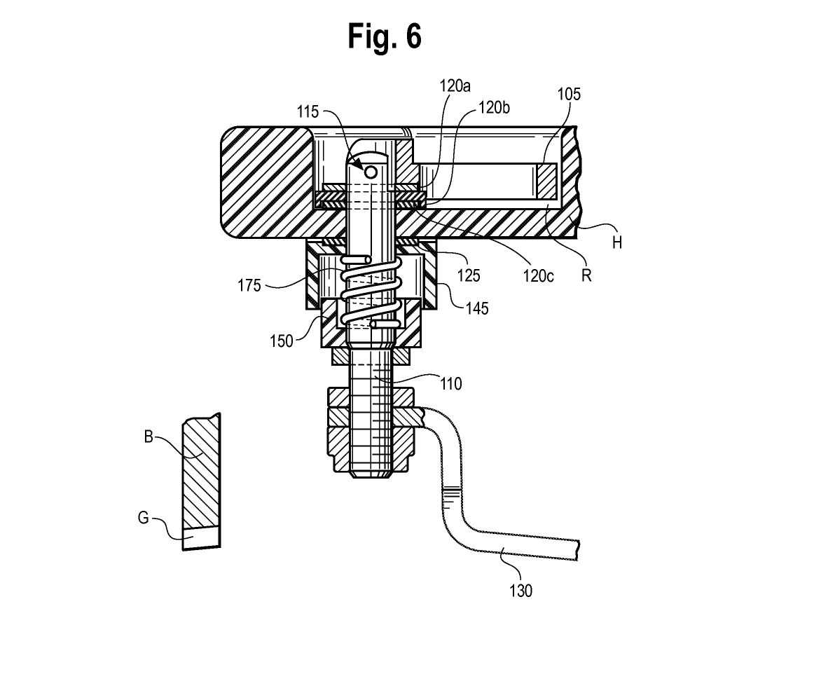

At this stage, the hinged body H is not yet capable of being opened from the base B because the first cam 130 is positioned just below the base B. Accordingly, the handle 105 can be rotated, which then rotates the first cam 130 away from the base B and allows the hinged body H to be lifted, as shown in FIG. 5. The handle 105 can then be placed in the folded-down configuration, as shown in FIG. 6, to conceal the handle within the recess R of the hinged body H while still allowing the latch 100 to be in the unlocked position.

In an embodiment, moving the handle 105 to the unlocked, folded-down position does not compress the bias member 175 like when the handle 105 is moved into the locked, folded-down position. As shown in FIGS. 5 and 6, the joint 115 does not substantially move upward when the handle 105 is folded down in the unlocked position, and therefore, the spring 175 is not compressed against the body 145 and lower washer 125. This is because the first 155 and second 160 members are shown as positioned on only one side of the handle 105 and therefore pull the shaft 110 upwardly only when the first 155 and second 160 members engage against the upper washer 120a and push the shaft 110 upwardly. However, in an embodiment, the first 155 and second 160 members are positioned on both sides of the handle 105 such that a substantially water-tight seal is created when the handle 105 is selectively positioned in the folded-down position, regardless of whether the latch 100 is in the locked or unlocked position.

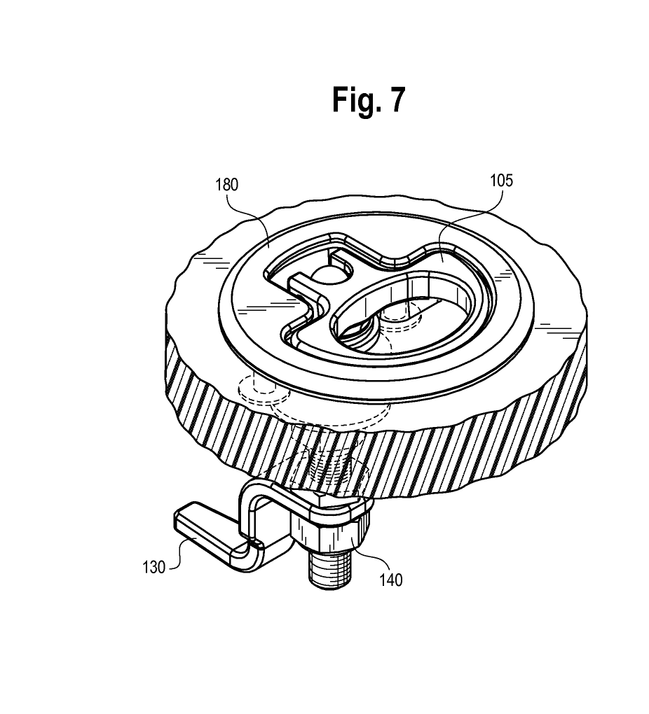

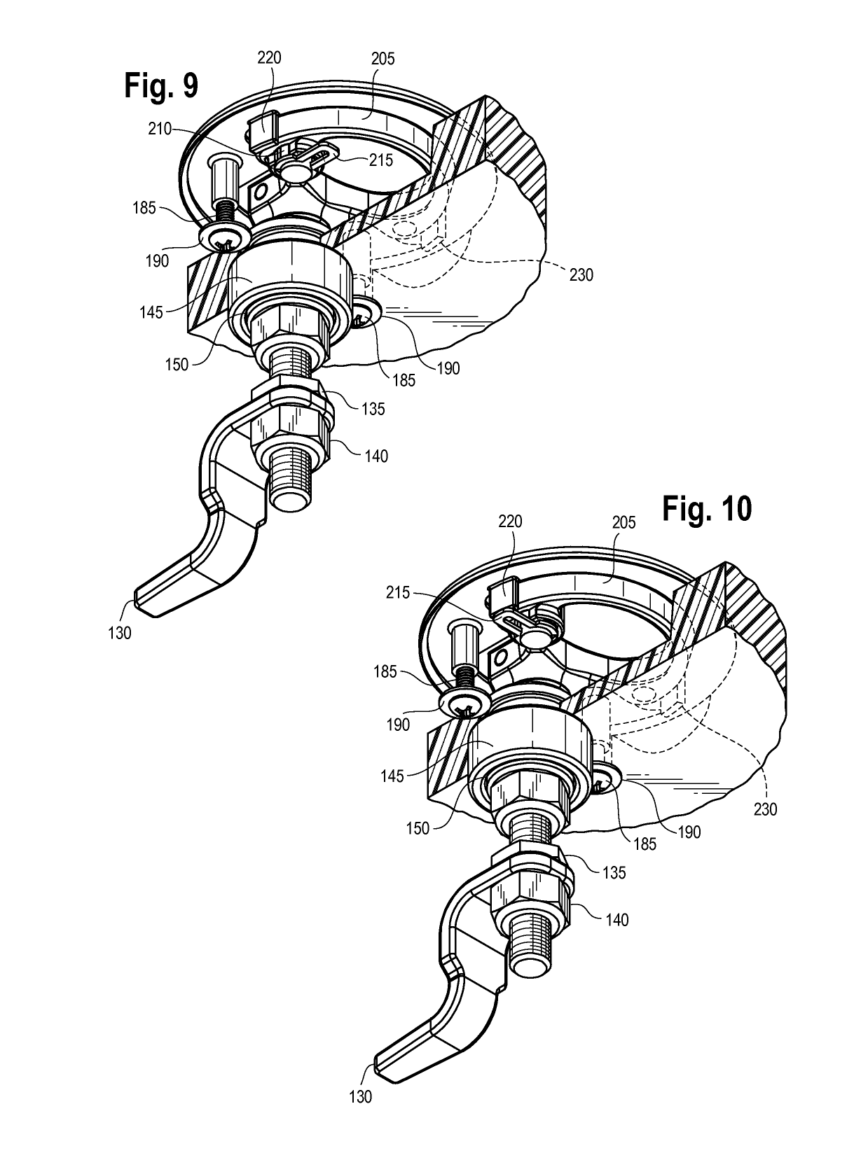

Referring to FIG. 7, in an embodiment, a trim ring 180 may be disposed on the hinged body H above the recess R. As illustrated, the trim ring 180 includes an aperture or opening complementary to the shape of the handles 105 and 205 to allow the handles 105 and 205 to be lifted and function as described above. The trim ring 180 may be used to provide an aesthetic appeal and/or to function as part of a locking device, as described in further detail below. The trim ring 180 may be coupled to the hinged body H by fasteners 185 (illustrated in FIG. 9), for example, screws or bolts, that extend through the hinged body H and couple to the trim ring 180. One or more washers 190 (illustrated in FIG. 9) may also be disposed between a head of the fasteners 185 and the hinged body H.

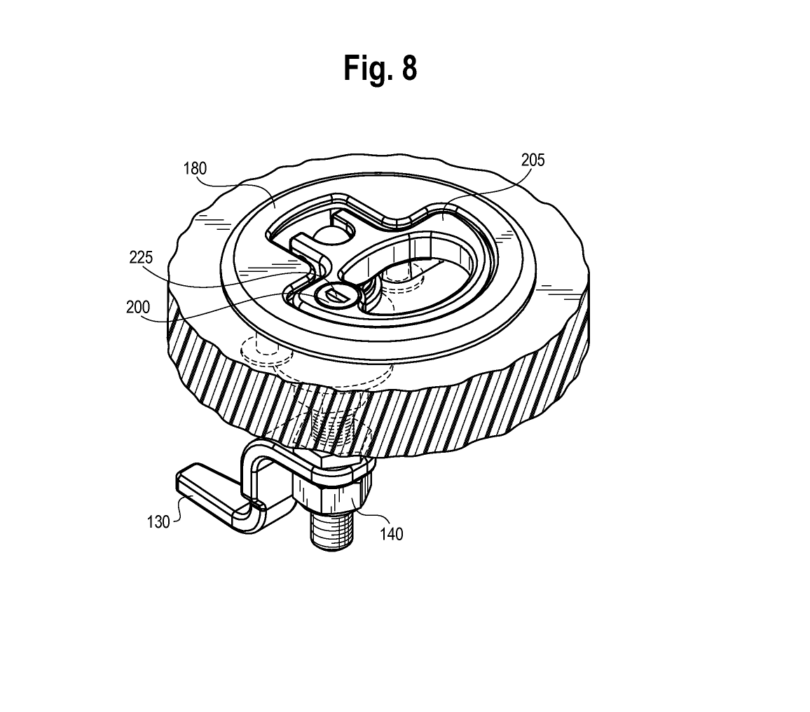

In an embodiment, the handle 105 of the latch 100 may be modified to include a handle locking feature. For example, referring to FIGS. 8-10, the handle 105 may be modified, resulting in handle 205 having a handle lock 200 that may be locked and unlocked by a key. The handle lock 200 extends through a hole in the handle 205 and includes a lock cylinder 210 and a second cam 215 that engages and disengages a locking tab 220 of the trim ring 180 extending into the recess R. For example, the handle lock 200 engages the locking tab 220 in a locked position, as illustrated in FIG. 10, and is disengaged from the locking tab 220 in an unlocked position, as illustrated in FIG. 9.

In the locked position, the handle lock 200 prevents the handle 205 from being lifted and the latch 100 being moved to the unlocked position. To move the handle lock 200 from the locked position to an unlocked position, a user inserts a key into a key hole 225 and rotates the key (for example, about 90 degrees) to cause the second cam 215 to rotate away from the locking tab 220, as illustrated in FIG. 9. In the unlocked position, the handle 205 may be lifted and the latch 100 may be moved to the unlocked position.

Referring to FIGS. 9 and 10, the trim ring 180 may also include a second tab 230. The second tab 230 is adapted to extend along the handle 105/205 when the handle 105/205 is in the folded down position. The second tab 230 may be a centering tab for the handle 105/205.

The trim ring 180 and the handle lock 200 provide additional security by allowing the handle 205 to be locked and unlocked by a key. This prevents unauthorized opening of the hinged body H by someone other than the user holding the key.

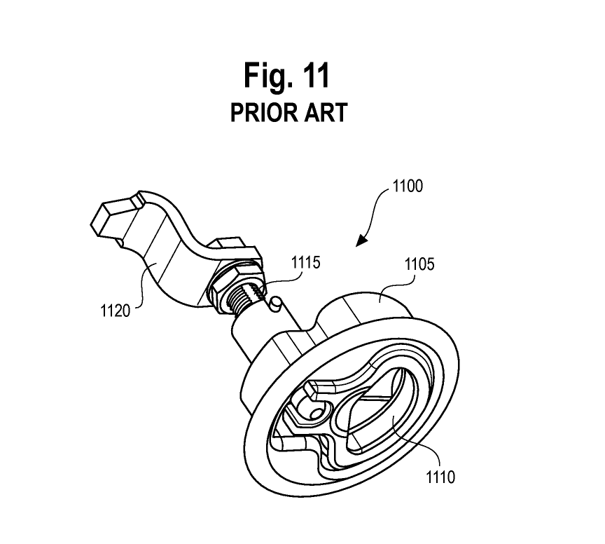

The above structure provides latches 100 and 200 that can be integral with the hinged body H and therefore do not require a separate housing that the latches 100 and 200 are disposed within. This structure provides several advantages, compared to the structure requiring a housing, for example, as disclosed in FIG. 11. For example, the latches 100 and 200 of the present application create a flush appearance rather than having a metallic housing protruding upwardly from the hinged body H. The flush appearance is more than aesthetic—it also reduces the chance of a user tripping or otherwise injuring himself/herself, compared to a latch that is not as flush. The lack of a dedicated housing also provides the advantage of customizability because the hinged body H can be formed around the latches 100 and 200 rather than around a larger housing that requires substantial space along the hinged body H.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A latch for selectively latching a hinged body, comprising:
a shaft extending through an aperture disposed in a recess of the hinged body;
a handle pivotably coupled to the shaft and adapted to be disposed in the recess on a first side of the hinged body and pivotable between upright and folded down positions;
a first cam disposed on the shaft opposite the handle on a second side of the hinged body, the first cam adapted to be selectively rotated between locked and unlocked positions in response to rotation of the handle between respective handle locked and unlocked positions;
a body disposed on the shaft between the first cam and the hinged body;
a cap disposed on the shaft between the first cam and the body; and
a bias member disposed on the shaft between the body and the cap and adapted to bias the cap away from the second side of the hinged body,
wherein when the handle is pivoted to the upright position, the shaft is biased in a downwardly direction and the first cam is rotatable between the locked and unlocked positions.

2. The latch of claim 1, further comprising an upper washer structure circumferentially disposed on the shaft between the handle and the hinged body.

3. The latch of claim 2, wherein the upper washer structure includes a first washer disposed proximal to the hinged body, a second washer disposed proximal to the handle, and a third washer disposed between the first and second washers.

4. The latch of claim 3, wherein the first washer is a sealing washer, the second washer is a wear washer, and the third washer is adapted to prevent over compression of the first washer when handle is disposed in the folded down position.

5. The latch of claim 1, further comprising a lower washer circumferentially disposed on the shaft between the body and the hinged body.

6. The latch of claim 1, further comprising a trim ring coupled to the hinged body above the recess.

7. The latch of claim 6, wherein the handle includes a handle lock having a lock cylinder extending through the handle and a second cam adapted to extend into the recess when the handle is in the folded down position.

8. The latch of claim 6, wherein the trim ring includes a locking tab adapted to extend into the recess, and a second cam is adapted to engage the locking tab in a handle locked position and be disengaged from the locking tab in a handle unlocked position.

9. A latching mechanism, comprising:
a compression latch installed in a recess of a hinged body, the compression latch including:
a shaft;
a handle pivotably coupled to the shaft and pivotable between upright and folded down positions and rotatable between locked and unlocked positions;
a lock cylinder extending through the handle and a first cam adapted to extend into the recess when the handle is in the folded down position; and
a second cam disposed on the shaft opposite the handle and rotatable between locked and unlocked positions in response to respective rotation of the handle between the locked and unlocked positions; and
a trim ring coupled to the hinged body above the recess and including:
a locking tab extending into the recess, wherein the first cam engages the locking tab when the handle is in the locked position and disengages the locking tab when the handle is in the unlocked position.

10. The latching mechanism of claim 9, wherein the compression latch further comprises an upper washer structure circumferentially disposed on the shaft between the handle and the hinged body.

11. The latching mechanism of claim 10, wherein the upper washer structure includes a first washer disposed proximal to the hinged body, a second washer disposed proximal to the handle, and a third washer disposed between the first and second washers.

12. The latching mechanism of claim 11, wherein the first washer is a sealing washer, the second washer is a wear washer, and the third washer is adapted to prevent over compression of the first washer.

13. The latching mechanism of claim 10, further comprising a lower washer circumferentially disposed on the shaft between the second cam and the hinged body.

14. A latch mechanism, comprising:
a compression latch adapted to be disposed in a recess of a hinged body and including a handle having a lock cylinder extending through the handle and a first cam adapted to extend into the recess when the latch is disposed in the recess and the handle is disposed in a folded down position; and
a trim ring adapted to be coupled to the hinged body above the recess and including a locking tab extending into the recess when the trim ring is coupled to the hinged body, the first cam adapted to engage the locking tab in a locked position and disengage the locking tab in an unlocked position.

15. The latch mechanism of claim 14, wherein the compression latch further includes a shaft and the handle is pivotably coupled to the shaft, and an upper washer structure circumferentially disposed on the shaft between the handle and the hinged body when the latch is disposed in the recess.

16. The latch mechanism of claim 15, wherein the upper washer structure includes a first washer disposed proximal to the hinged body when the latch is disposed in the recess, a second washer disposed proximal to the handle, and a third washer disposed between the first and second washers.

17. The latch mechanism of claim 14, wherein the compression latch further includes a shaft and the handle pivotably coupled to the shaft, and a second cam disposed on the shaft opposite the handle, wherein in response to the handle being pivoted to an upright position, the shaft is biased in a downwardly direction and the first cam is rotatable between the locked and unlocked positions.

18. The latch mechanism of claim 14, wherein the trim ring includes a centering tab adapted to extend into the recess when the trim ring is coupled to the hinged body and align the handle therein.

19. The latch mechanism of claim 14, wherein the lock cylinder includes an aperture adapted to receive a key, and the first cam is adapted to be rotated between the locked and unlocked positions in response to rotation of the key.

20. A latch for selectively latching a hinged body, comprising:
a shaft extending through an aperture in a recess of the hinged body when the latch is installed in the hinged body;
a handle pivotably coupled to the shaft and pivotable between upright and folded down positions, the handle including a lock cylinder extending through the handle and a cam coupled to the lock cylinder, the cam being selectively rotatable between handle locked and unlocked positions, the handle being disposed in the recess on a first side of the hinged body and the cam extending into the recess when the handle is in the folded down position and the latch is installed;
a first sealing washer circumferentially disposed on the shaft between the handle and the first side of the hinged body when the latch is installed;
a second washer circumferentially disposed on the shaft between the handle and the sealing washer, the second washer adapted to prevent over compression of the first washer when the handle is in the folded down position;
a wear washer circumferentially disposed on the shaft between the handle and the second washer;
a latching cam disposed on the shaft opposite the handle and on a second side of the hinged body when the latch is installed, the latching cam adapted to be selectively rotated between locked and unlocked positions in response to rotation of the handle;
a cap disposed on the shaft between the latching cam and the hinged body when the latch is installed;
a body disposed on the shaft between the cap and the hinged body when the latch is installed, the body being adapted to receive the cap;
a second sealing washer circumferentially disposed on the shaft between the body and the hinged body when the latch is installed; and
a bias member disposed on the shaft between the body and the cap and adapted to bias the body and the second sealing washer toward the hinged body and bias the cap away from the hinged body, wherein when the handle is pivoted to the upright position, the shaft is biased in a downwardly direction and the latching cam is rotatable between the locked and unlocked positions.

21. The latch of claim 20, further comprising a trim ring adapted to be coupled to the hinged body above the recess and including a locking tab extending into the recess when the trim ring is coupled to the hinged body and the cam adapted to selectively engage the locking tab in the handle locked position and be disengaged from the locking tab in the handle unlocked position.
